(19) United States
(12) Patent Application Publication
(10) Pub. No.: US 2021/0026142 A1
(43) Pub. Date: Jan. 28, 2021

(54) INFORMATION PROCESSING APPARATUS, INFORMATION PROCESSING METHOD, AND PROGRAM

(71) Applicant: SONY CORPORATION, TOKYO (JP)

(72) Inventor: TOMOHIKO GOTOH, KANAGAWA (JP)

(21) Appl. No.: 17/040,142

(22) PCT Filed: Jan. 10, 2019
(86) PCT No.: PCT/JP2019/000422

§ 371 Date: Sep. 22, 2020

(30) Foreign Application Priority Data
Mar. 30, 2018 (JP) 2018-066736

(51) Int. Cl. G02B 27/01; H04N 5/235; H04N 5/225; G06T 7/20; G06T 19/00

(52) U.S. Cl. CPC G02B 27/0172; H04N 5/2351; H04N 5/2256; G02B 2027/0138; G06T 19/006; G02B 2027/0178; G06T 7/20

(57) ABSTRACT

[Problem] Provided are an information processing apparatus, an information processing method, and a program, which are capable of performing display control to avoid a decrease of visibility of a virtual object. [Solution] An information processing apparatus includes a control unit that performs display control to dispose a virtual object preferentially on a second region rather than on a first region, the first region being a region in a real space from which first visibility is obtained, and the second region being a region in the real space from which second visibility higher than the first visibility is obtained.

### FIELD

The present invention relates to an information processing apparatus, an information processing method, and a program.

### BACKGROUND

In recent years, a technology has been widely used, which is called augmented reality (AR) or mixed reality (MR), which superimposes additional information in a real space and augments a real environment perceived by human beings, and information presentation that applies the AR or MR technology has been performed. Information presented to a user is visualized using virtual objects in a variety of modes such as text, icons, images, and 3D models.

Mainly used displays for superimposing and displaying a virtual 3D object or the like on the real world in the AR or MR technology include two types of displays (display devices) which are an optical transmission-type display and a video transmission-type display.

The video transmission-type display has a structure of covering a visual field with the display, and the real world and a virtual object are visualized as a video taken in real time. Meanwhile, the optical transmission-type display enables visual recognition of the virtual object simultaneously with naked-eye visual recognition of the real world, is suitable for outdoor AR or MR in terms of safety and video quality, and has a large possibility of further spreading as an instrument for enjoying AR or MR contents outdoors in the future. Regarding the optical transmission-type display, for example, the following Patent Literature 1 describes that a transmittance of a display area may be adjusted according to a quantity of external light.

### CITATION LIST

### Patent Literature

Patent Literature 1: JP 2013-210643 A

### SUMMARY

### Technical Problem

However, in the case of the optical transmission-type display, video display is performed by drawing the virtual object on a transmission-type screen by projection light by an instrument, and accordingly, in principle, particularly under an environment with an extremely high illumination intensity, onto which sunlight is directly applied and so on, the real world becomes extremely bright as compared with the displayed virtual object, and the virtual object becomes extremely difficult to see.

In this connection, the present disclosure proposes an information processing apparatus, an information processing method, and a program, which are capable of performing display control to avoid a decrease of visibility of the virtual object.

### Solution to Problem

According to the present disclosure, an information processing apparatus is provided that includes: a control unit that performs display control to dispose a virtual object preferentially on a second region rather than on a first region, the first region being a region in a real space from which first visibility is obtained, and the second region being a region in the real space from which second visibility higher than the first visibility is obtained.

According to the present disclosure, an information processing method is provided that includes: performing, by a processor, display control to dispose a virtual object preferentially on a second region rather than on a first region, the first region being a region in a real space from which first visibility is obtained, and the second region being a region in the real space from which second visibility higher than the first visibility is obtained.

According to the present disclosure, a program is provided that causes a computer to: function as a control unit that performs display control to dispose a virtual object preferentially on a second region rather than on a first region, the first region being a region in a real space from which first visibility is obtained, and the second region being a region in the real space from which second visibility higher than the first visibility is obtained.

### Advantageous Effects of Invention

According to the present disclosure described above, it becomes possible to perform the display control to avoid the decrease of the visibility of the virtual object.

The above-described effect is not necessarily limited, and any of the effects indicated in the present description or other effects which can be grasped from the present description may be exerted together with the above-described effect or in place of the above-described effect.

### BRIEF DESCRIPTION OF DRAWINGS

FIG. 1 is a diagram explaining an overview of an information processing system according to an embodiment of the present disclosure.

FIG. 2 is a block diagram illustrating an exterior appearance example of an information processing apparatus according to the present embodiment.

FIG. 3 is a block diagram illustrating a configuration example of the information processing apparatus according to the present embodiment.

FIG. 4 is a diagram explaining an example of a light source position estimation algorithm when the light source according to the present embodiment is the sun.

FIG. 5 is a diagram illustrating an example of an algorithm for determining a destination of a virtual object according to the present embodiment.

FIG. 6 is a flowchart illustrating an example of a flow of output control processing according to the present embodiment.

FIG. 7 is a flowchart illustrating an example of a flow of user's visual field estimation processing according to the present embodiment.

FIG. 8 is a flowchart illustrating an example of a flow of estimation processing for a light source position according to the present embodiment.

FIG. 9 is a flowchart illustrating an example of destination determination processing for a virtual object according to the present embodiment.

FIG. 10 is a flowchart illustrating an example of destination determination processing accompanied by a movement route change of the virtual object according to the present embodiment.

FIG. 11 is a diagram explaining the movement route change of the virtual object according to the present embodiment.

### DESCRIPTION OF EMBODIMENTS

Preferred embodiments of the present disclosure will be described below in detail with reference to the accompanying drawings. In the present description and the drawings, the same reference numerals will be assigned to components having substantially the same functional configurations, and a duplicate description thereof will be omitted.

Moreover, the description will be given in the following order.
1. Overview of information processing system according to an embodiment of the present disclosure
2. Configuration example
3. Operation processing
3-1. Output control processing
3-2. User's visual field estimation processing
3-3. Sun position estimation processing
3-4. Destination determination processing
4. Use cases
5. Summary

### 1. Overview of Information Processing System According to Embodiment of the Present Disclosure

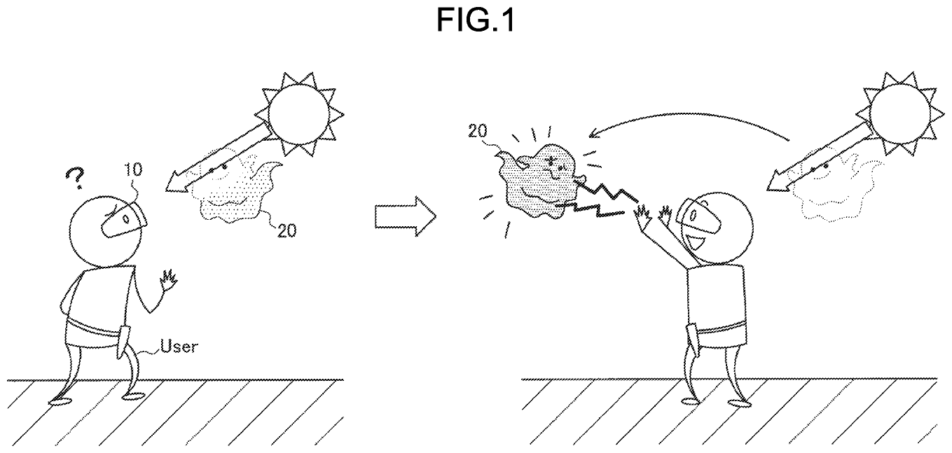

FIG. 1 is a diagram explaining an overview of an information processing system according to an embodiment of the present disclosure. As illustrated in FIG. 1, the information processing system according to the present embodiment can display a virtual object at any position in the real space using an optical transmission-type display (information processing apparatus 10) worn by a user on the head, and can present AR and MR contents of games, information provision and the like (hereinafter referred to as AR contents).

### Background

Here, as mentioned above, in the case of the optical transmission-type display, video display is performed by drawing a virtual object on a transmission-type screen by projection light by an instrument, and accordingly, in principle, particularly under an environment with an extremely high illumination intensity, onto which sunlight is directly applied and so on, such a problem occurs that the real world becomes extremely bright as compared with the displayed virtual object, resulting in that the virtual object becomes extremely difficult to see. For example, in the case of an AR game content that causes an enemy character or item to appear outdoors in association with a position in the real space, such a phenomenon may occur in which the sunshine is too bright to make a virtual object 20 visible as illustrated on the left side of FIG. 1.

Moreover, also in the case of recognizing a user's hand by a camera installed in the instrument for the purpose of interaction with the AR content, and so on, backlight may exceed an exposure adjustment range of the camera when the instrument is used outdoors, and a shape of the hand may not be able to be recognized correctly. For example, when such an interaction is performed as attacking an enemy character, which appears in the real space, by holding the user's hand thereto, the interaction cannot be generated if the user's hand is not correctly recognizable due to the backlight, and the user cannot enjoy the game.

As a countermeasure against such a decrease of the visibility due to an influence of external light, conceivable is a method of suppressing a quantity of passing incident light by a dimming function of light-shielding glass or a transmission-type display. However, the real world looks entirely dark, and an experience value of the AR content in which the virtual object is superimposed on the real world while the real world looks natural will be greatly impaired.

Accordingly, in the present embodiment, an information processing system that performs display control to avoid the decrease of the visibility of the virtual object due to external light is proposed. Specifically, an information processing system according to the present embodiment avoids the decrease of the visibility of the virtual object due to external light by performing display control to dispose a virtual object preferentially on a second region rather than on a first region, the first region being a region in the real space from which first visibility is obtained, and the second region being a region in the real space from which second visibility higher than the first visibility is obtained. The visibility is such visibility of the virtual object, and for example, the second region from which the second visibility higher than the first visibility is obtained can be determined based on an illuminance environment. The illuminance environment may be illuminance information obtained by sensing (in real time by an illuminance sensor installed in an information processing apparatus 10 or an illuminance sensor installed on an environment side), or may be position information of a light source.

For example, when the illuminance environment is in illuminance information obtained by the sensing, the first region may be a region having an illuminance that exceeds a first threshold, and the second region may be a region having an illuminance that is less than the first threshold. The region having the illuminance that exceeds the first threshold value is assumed to be a region illuminated by strong light from a natural light source such as the sun or an artificial light source such as a spotlight. This is because the virtual object is difficult to see (visibility is reduced) in a too bright region. Meanwhile, when the illuminance environment is position information of the light source, the first region may be a region including a direction in which the light source is located with respect to a position of the user, and the second region may be a region including a direction opposite to the direction in which the light source is located with respect to the position of the user. The light source may be a natural light source such as the sun or an artificial light source such as a spotlight. The information processing system according to the present embodiment estimates a position of the light source by a known position information database or calculation, and performs disposition control of the virtual object based on a positional relationship with a current position of the user. For example, “the region including the direction in which the light source is located with respect to the user's position” (first region) is a range in which the light source comes into a user's visual field, and “the region including the direction opposite to the direction in which the light source is located with respect to the position of the user” (second region) is a range in which the light source does not come into the user's visual field. Further, the illuminance environment may further include position information of a shield, and a region shaded by the shield may be defined to be the second region. Moreover, the information processing system according to the present embodiment may determine the first and second regions as the illuminance environment by considering both the illuminance information obtained by the sensing and the position information of the light source.

As described above, for example, the information processing system according to the present embodiment controls the virtual object to be disposed in the range where the light source does not come into the user's visual field (this range is an example of the second region), thus making it possible to avoid the decrease of the visibility of the virtual object due to external light. For example, as illustrated on the right side of FIG. 1, when the information processing apparatus 10 according to the present embodiment moves a virtual object 20 to a place where the light source does not come into the user's visual field, the user moves the line of sight by visually following the moving virtual object 20. Therefore, the user naturally turns his/her back to the sun, and the user can see the virtual object 20 in a highly visible place where the light source does not come into the visual field.

Moreover, by the fact that the user naturally turns his/her back to the sun, a backlight condition is eliminated, and it becomes possible to prevent accuracy of recognition by the camera from decreasing.

### Example of Exterior Appearance of Information Processing Apparatus 10

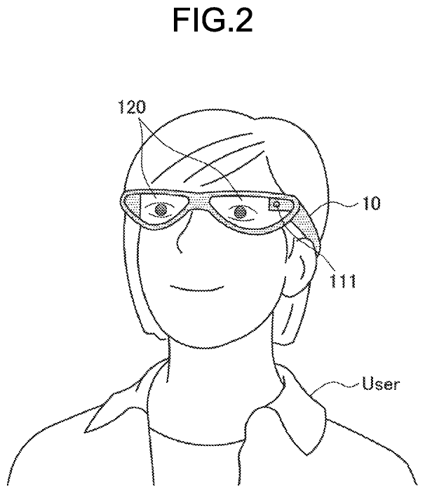

FIG. 2 is a diagram explaining an exterior appearance example of the information processing apparatus 10 according to the present embodiment. As illustrated in FIG. 2, the information processing apparatus 10 according to the present embodiment is achieved by, for example, a glasses-type head mounted display (HMD) mounted on the user's head. A display unit 120, which corresponds to a spectacle lens portion located in front of user's eyes when worn, may be a so-called optical see-through display having optical transparency. By displaying the virtual object on the display unit 120, the information processing apparatus 10 can present the virtual object within the user's visual field. Further, the HMD, which is an example of the information processing apparatus 10, is not limited to one that presents an image to both eyes, and may be one that presents an image to only one eye. For example, the HMD may be a one-eye type in which such a display unit 120 that presents an image to one eye is provided.

Further, the information processing apparatus 10 is provided with an outward facing camera 111 that captures a visual line direction of the user, that is, the user's visual field when the information processing apparatus 10 is worn. Moreover, although not illustrated in FIG. 2, the information processing apparatus 10 may be provided with an inward facing camera that captures an image of the user's eye when the information processing apparatus 10 is worn and with various sensors such as a microphone. A plurality of the outward facing cameras 111 and a plurality of the inward facing cameras may be provided.

A shape of the information processing apparatus 10 is not limited to the example illustrated in FIG. 2. For example, the information processing apparatus 10 may be a headband-type (type that is worn with a band that goes around the entire circumference of the head. Further, a band that passes not only on the side of the head but also on the top of the head may be provided) HMD, or may be a helmet-type (a visor portion of a helmet corresponds to the display unit 120) HMD.

Here, for example, when the display unit 120 has optical transparency, the user can visually recognize information displayed on the display unit 120 while visually recognizing the real space through the display unit 120. Hence, it can be said that the virtual object displayed on the display unit 120 is displayed in the real space.

Further, such control can be performed as to cause the user to feel as if the virtual object existed in the real space. For example, disposition, shape and the like of the virtual object can be controlled based on information on the real space, which is obtained by image pickup by the outward facing camera 111, for example, based on information on a position and shape of a real object existing in the real space.

The virtual objects displayed on the display unit 120 can be various. For example, the virtual object may be a virtual object indicating various contents depending on an application provided by the information processing apparatus 10. Alternatively, the virtual object may be a virtual object for emphasizing a real object, to which the user is desired to pay attention, among real objects existing in the real space.

The information processing system according to the embodiment of the present disclosure has been described above. Next, a specific configuration and operation processing of the information processing apparatus 10 that achieves the information processing system according to the present embodiment will be described more in detail.

### 2. Configuration Example

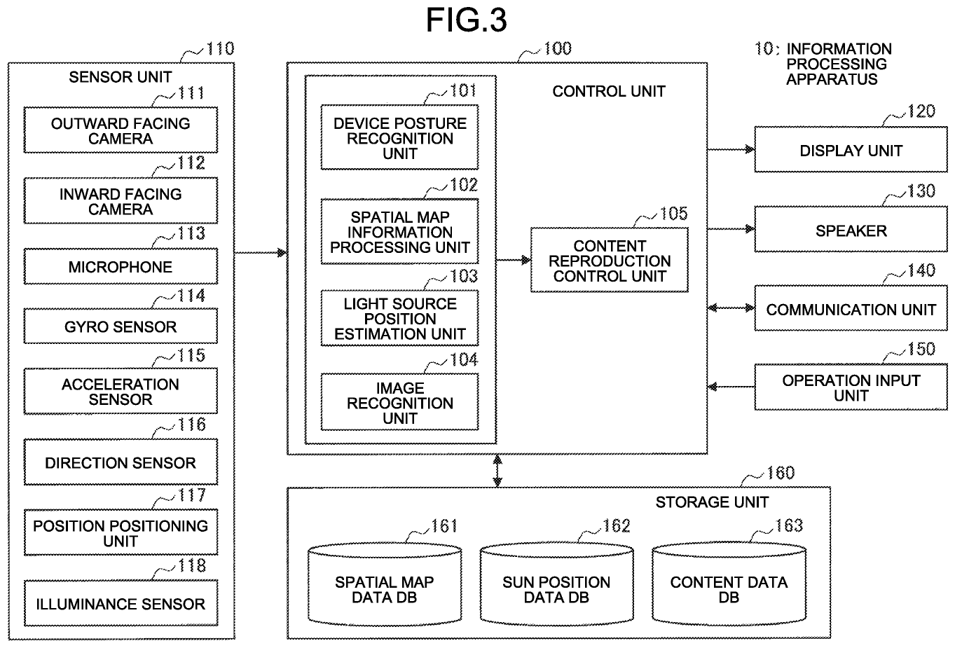

FIG. 3 is a block diagram illustrating a configuration example of the information processing apparatus 10 according to the present embodiment. As illustrated in FIG. 3, the information processing apparatus 10 includes a sensor unit 110, a control unit 100, the display unit 120, a speaker 130, a communication unit 140, an operation input unit 150, and a storage unit 160.

### 2-1. Sensor Unit 110

The sensor unit 110 has a function to acquire (sense) a variety of information regarding the user or a surrounding environment. For example, the sensor unit 110 includes an outward facing camera 111, an inward facing camera 112, a microphone 113, a gyro sensor 114, an acceleration sensor 115, a direction sensor 116, a position positioning unit 117, and an illuminance sensor 118. A specific example of the sensor unit 110 mentioned here is merely an example, and the present embodiment is not limited to this. For example, the sensor unit 110 may include a biometric sensor, an inward facing camera, or the like. Further, each sensor may be plural.

Each of the outward facing camera 111 and the inward facing camera 112 includes: a lens system composed of an imaging lens, a diaphragm, a zoom lens, a focus lens, and the like; a drive system that causes the lens system to perform a focus operation and a zoom operation; a solid-state imaging element array that photoelectrically converts imaging light obtained by the lens system to generate an imaging signal; and the like. The solid-state imaging element array may be achieved by, for example, a charge coupled device (CCD) sensor array or a complementary metal oxide semiconductor (CMOS) sensor array.

In the present embodiment, it is desirable that an angle of view and orientation of the outward facing camera 111 be set so that the outward facing camera 111 captures an image of a region corresponding to the user's visual field in the real space. Moreover, a plurality of the outward facing cameras 111 may be provided. Furthermore, the outward facing camera 111 may include a depth camera capable of acquiring a depth map by sensing.

The microphone 113 collects a user's voice and surrounding environmental sounds, and outputs the collected sounds as voice data to the control unit 100.

The gyro sensor 114 is achieved by, for example, a 3-axis gyro sensor, and detects an angular velocity (rotational speed).

The acceleration sensor 115 is achieved by, for example, a 3-axis acceleration sensor, and detects an acceleration during movement.

The direction sensor 116 is achieved by, for example, a 3-axis geomagnetic sensor (compass), and detects an absolute direction (azimuth).

The position positioning unit 117 calculates a self-position of the information processing apparatus 10. For example, the position positioning unit 117 may use so-called simultaneous localization and mapping (SLAM) as a self-position estimation method. An algorithm of SLAM is not particularly limited, but for example, Landmark based SLAM that uses a landmark represented by point coordinates on a map may be used. Landmark based SLAM recognizes a characteristic object as a landmark, generates a map of the landmark, and feeds back to self-position estimation using the coordinate information of the landmark.

Further, the position positioning unit 117 may detect a current position of the information processing apparatus 10 based on a signal acquired from the outside. Specifically, for example, the position positioning unit 117 is achieved by a global positioning system (GPS) positioning unit, receives radio waves from GPS satellites, detects a position where the information processing apparatus 10 is present, and outputs information on the detected position to the control unit 100. Further, the position positioning unit 117 may be a unit that detects the position by, for example, Wi-Fi (registered trademark), Bluetooth (registered trademark), transmission/reception with a mobile phone/PHS/smartphone, near field communication, or the like as well as the GPS.

The illuminance sensor 118 is achieved by, for example, a photodiode or the like, and detects brightness.

### 2-2. Control Unit 100

The control unit 100 functions as an arithmetic processing device and a control device, and controls overall operations in the information processing apparatus 10 according to various programs. For example, the control unit 100 is achieved by an electronic circuit such as a central processing unit (CPU) and a microprocessor. Further, the control unit 100 may include a read only memory (ROM) that stores a program and calculation parameters, and the like, which are for use, and a random access memory (RAM) that temporarily stores parameters, and the like, which appropriately change. Moreover, the control unit 100 according to the present embodiment has a various information processing function and an output control function.

### 2-2-1. Information Processing Function

As illustrated in FIG. 3, the control unit 100 can function as a device posture recognition unit 101, a spatial map information processing unit 102, a light source position estimation unit 103, and an image recognition unit 104.

The device posture recognition unit 101 recognizes a posture of the device mounted on the user's head, that is, a posture of the information processing apparatus 10 (the posture corresponds to a posture of the user's head) based on various sensor information (sensing results) sensed by the sensor unit 110. As such information on the device posture, for example, information such as an orientation of the user's face and an inclination of the user's body can be recognized. More specifically, for example, the device posture recognition unit 101 can detect the device posture from detection results of the outward facing camera 111, the gyro sensor 114, the acceleration sensor 115, and the direction sensor 116. Further, the device posture recognition unit 101 can also recognize a three-dimensional position of the user's head in the real space based on these pieces of information.

The spatial map information processing unit 102 can acquire spatial information around the user based on spatial map data registered in advance in a spatial map data DB (database) 161, and based on the various sensor information (sensing results) sensed by the sensor unit 110. The spatial map data includes a three-dimensional recognition result of the real space in a predetermined range and a recognition result of a real object existing in the real space. For example, the spatial map information processing unit 102 can collate a face orientation of the user, which is obtained from a device posture result, a three-dimensional position information obtained by the position positioning unit 117, and the spatial map data with one another, and can determine what kind of real object is present in the user's visual field (that is, what is in the user's visual field range). Further, the spatial map information processing unit 102 is also able to recognize a surrounding space based on the various sensor information (sensing results) sensed by the sensor unit 110, and to newly generate or update spatial map data.

The light source position estimation unit 103 estimates a light source position based on the various sensor information (sensing result) sensed by the sensor unit 110. The light source is assumed to be, for example, the sun (natural light source), or an illumination device (artificial light source) such as an outdoor light, a spotlight, and a lighting tower in a stadium or the like. Further, the sun and lighting, which reflect off a glass wall, can also be assumed. Positions of the artificial light source such as a lighting device and the glass wall or the like can be acquired from known spatial map data (position information database in which the artificial light source and the like are known), and accordingly, the light source position estimation unit 103 uses such known position information for estimating these light sources. Meanwhile, when the light source is the sun, the position of the light source changes with time, and accordingly, the light source position estimation unit 103 appropriately calculates the position of the light source using a predetermined algorithm. In the present embodiment, it is also naturally possible to control a display position of the content in consideration of both the sun and the artificial light source.

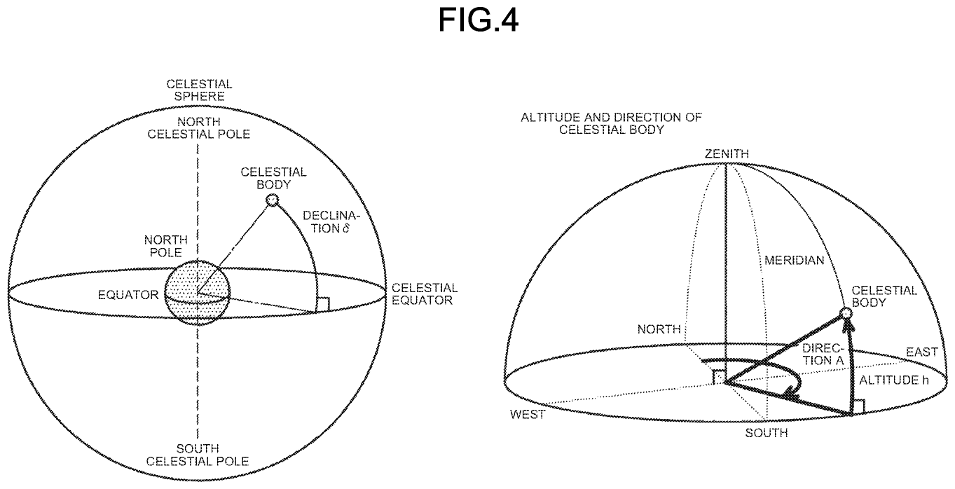

Here, an example of a light source position estimation algorithm when the light source is the sun will be described with reference to FIG. 4. An altitude (elevation angle) h of the sun and an azimuth angle A (the clockwise direction is positive when the north is 0°) thereof on the ground are obtained by the following equations with reference to FIG. 4.

In the following equations, a declination of the sun (an angle between the sunlight and the equatorial plane of the earth) is δ, a north latitude of a current position is ϕ, and an east longitude thereof is θ.
Altitude (elevation angle): h

h=asin(sin(ϕ)sin(δ)+cos(ϕ)cos(δ)cos(t))
Azimuth angle: A(North=0, East=90, South=180, West=270°)

sinA=cos(δ)sin(t)/cos(h)

cosA=(sin(h)sin(ϕ)−sin(δ))/cos(h)/cos(ϕ)

A=atan2(sinA,cosA)+π

Among these, the current position (ϕ, θ) can be acquired from positioning of the device. Further, since the declination δ of the sun is a constant determined by date, calculation thereof can be omitted by storing such declinations δ of the sun as a table in the sun position data DB 162.

The image recognition unit 104 can perform recognition processing of images captured by the outward facing camera 111 and the inward facing camera 112. For example, the image recognition unit 104 recognizes a shape of the user's hand from the image captured by the outward facing camera 111.

### 2-2-2. Output Control Function

Further, as illustrated in FIG. 3, the control unit 100 can function as a content reproduction control unit 105.

Using the display unit 120 and the speaker 130, the content reproduction control unit 105 performs reproduction output control (content display control, content audio control) of the content acquired from the sun position data DB 162 based on the various sensor information sensed by the sensor unit 110 (sensing results) and various information processing mentioned above (device posture recognition result, spatial map information processing result, light source position estimation result, and image recognition result). Specifically, the content reproduction control unit 105 controls the display by the display unit 120 having optical transparency to display the virtual object in the real space. In order to cause the user to feel as if the virtual object existed in the real space, the content reproduction control unit 105 performs display control, for example, so that a feeling of wrongness does not occur in a positional relationship between the real object existing in the real space and the virtual object. For example, based on information on the position and shape of the real object, the content reproduction control unit 105 performs such display control that the virtual object is displayed while shielding a portion existing on the far side of the real object as seen from the user so that the positional relationship between the real object and the virtual object is expressed appropriately.

Further, when rules such as an appearance position, an appearance range, and a movement route are set for each virtual object, the content reproduction control unit 105 performs the reproduction output control according to the rules. These rules can be stored as content data in a content data DB 163.

Moreover, the content reproduction control unit 105 can also perform interaction control with the content according to a user's movement, utterance, or the like. For example, when the user performs a predetermined action, the content reproduction control unit 105 performs control to cause a predetermined interaction, such as a sound effect or a display change of the virtual object in response to a user's action.

Furthermore, the content reproduction control unit 105 according to the present embodiment refers to a position of the user and a position of the light source when the virtual object is displayed or moved according to the above rules, and performs processing to move the virtual object to a predetermined range or to change the movement route thereof in order to avoid the decrease of the visibility of the virtual object due to the light source. This makes it possible to further enhance the experience value of the AR content.

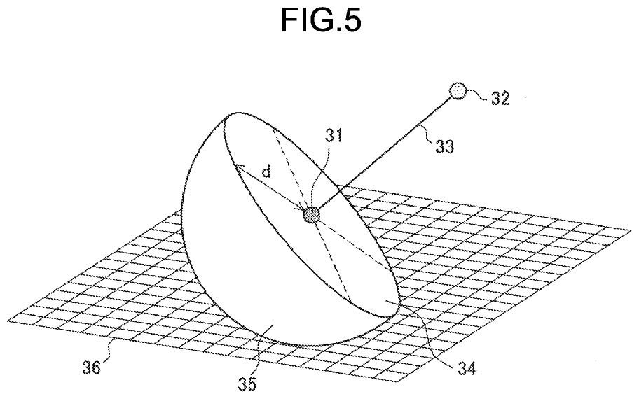

More specifically, the content reproduction control unit 105 performs control to dispose the virtual object in a range where the light source does not enter the user's visual field based on the user's visual field and an estimated light source position. Here, an example of an algorithm for determining a destination of the virtual object according to the position of the user and the position of the light source will be described with reference to FIG. 5.

As illustrated in FIG. 5, for example, in an area surrounded by a spherical surface of which center is a viewpoint position 31 of the user (for example, a center between eyes) and whose maximum display distance d of the virtual object is a radius, and by a plane 34 orthogonal to a straight line that connects the viewpoint position 31 of the user and the light source position 32 to each other (here, the straight line is called an optical axis 33), the content reproduction control unit 105 defines a region, which is farther from the light source (on the side opposite to the light source) (here, this region is referred to as a light back area 35), as the destination of the virtual object. The user visually follows the virtual object that moves to the light back area 35, whereby the user naturally turns his/her back to the light source. In this case, the user can see the virtual object in a situation where the light source does not enter the user's visual field, and the visibility of the virtual object is enhanced.

Further, the content reproduction control unit 105 prevents the destination from entering below a ground surface 36 when determining the destination within the light back area 35. The maximum display distance d of the virtual object may be determined from a range in which spatial map collation is possible (for example, within a range of the spatial map data registered in advance in the spatial map data DB 161), or from a range in which distance measurement by a sensor is possible. When the maximum display distance d of the virtual object cannot be acquired, the content reproduction control unit 105 may assume, for example, that the maximum display distance d is approximately 15 m. Moreover, the light back area 35 has simply a hemispherical shape in the example illustrated in FIG. 5, but the present embodiment is not limited to this.

Further, the content reproduction control unit 105 may predict the movement of the user, may calculate, as the light back area 35, a range where the light source does not enter the user's visual field even if the user moves to some extent, and may determine the destination of the virtual object.

Further, in the case of a content that presents a virtual object commonly to a plurality of users, the content reproduction control unit 105 may consider the visual fields of the plurality of users, may calculate, as the light back area 35, a range where the light source does not enter the visual fields of all of the users, and may determine the destination of the virtual object.

### 2-3. Display Unit 120

The display unit 120 is achieved by a lens unit, a liquid crystal display (LCD) device, an organic light emitting diode (OLED) device, or the like, which has optical transparency, and for example, performs display using an optical hologram technology. The display unit 120 may be of a transmissive type, a semi-transmissive type, or a non-transmissive type. Further, the optical transparency of the display unit 120 may be controlled by the control unit 100.

### 2-4. Speaker 130

The speaker 130 reproduces an audio signal under the control of the control unit 100.

### 2-5. Communication Unit 140

The communication unit 140 is a communication module for transmitting/receiving data to/from another device by wire/wirelessly. The communication unit 140 performs wireless communication with an external instrument directly or via a network access point by a system, for example, such as wired local area network (LAN), wireless LAN, Wireless Fidelity (Wi-Fi) (registered trademark), infrared communication, Bluetooth (registered trademark), and near field/non-contact communication.

### 2-6. Operation Input Unit 150

The operation input unit 150 is achieved by an operation member having a physical structure, such as a switch, a button, and a lever.

### 2-7. Storage Unit 160

The storage unit 160 is achieved by a read only memory (ROM) that stores a program and calculation parameters, and the like, which are for use in the above-mentioned processing of the control unit 100, and a random access memory (RAM) that temporarily stores parameters, and the like, which appropriately change.

Further, the storage unit 160 stores the spatial map data DB 161, the sun position data DB 162, and the content data DB 163. The spatial map data DB 161 stores a spatial map which is three-dimensionally recognized by the real space, a depth camera or the like, and which indicates the position, shape, and the like of a real object existing in the space. The spatial map data may be generated by the spatial map information processing unit 102, or space map data in a predetermined range (for example, the range of the AR game content provided) may be registered in advance. The sun position data DB 162 stores parameters for use when estimating the position of the sun. As mentioned above, for example, since the declination δ of the sun is a constant determined by date, calculation thereof can be omitted by storing such declinations δ of the sun as a table in the sun position data DB 162. The content data DB 163 stores various content data such as the AR game content. The spatial map data, the sun position data, and the content data may be stored in the information processing apparatus 10, or may be acquired from a predetermined server on a network through the communication unit 140.

Although the configuration of the information processing apparatus 10 according to the present embodiment has been specifically described above, the configuration of the information processing apparatus 10 according to the present embodiment is not limited to the example illustrated in FIG. 3. For example, the information processing apparatus 10 may be composed of a plurality of devices. Specifically, for example, the information processing apparatus 10 according to the present embodiment may have a system configuration composed of an HMD worn by the user and a smartphone. In this case, for example, the smartphone may be provided with the function of the control unit 100, and information may be presented by the HMD according to the control of the smartphone.

Further, at least a part of the sensor unit 110 may be an external sensor (for example, an environment sensor such as a camera, a depth sensor, a microphone, an infrared sensor, and an illuminance sensor, which are installed in a room).

Further, at least a part of the functions of the control unit 100 of the information processing apparatus 10 may exist in another device communicatively connected via the communication unit 140. For example, at least a part of the functions of the control unit 100 of the information processing apparatus 10 may be provided in an intermediate server, a cloud server on the Internet or the like. Further, a level of the processing performed by the control unit 100 may be simplified, and advanced processing may be performed by an external device, for example, another mobile device such as a smartphone owned by the user, a home server, an edge server, an intermediate server, or a cloud server. The processing is thus distributed to the plurality of devices, whereby a load is reduced.

The functional configuration of the information processing apparatus 10 according to the present embodiment is flexibly modifiable according to the specifications and the operations.

### 3. Operation Processing

Next, operation processing of the information processing system according to the present embodiment will be specifically described with reference to the drawings.

### 3-1. Output Control Processing

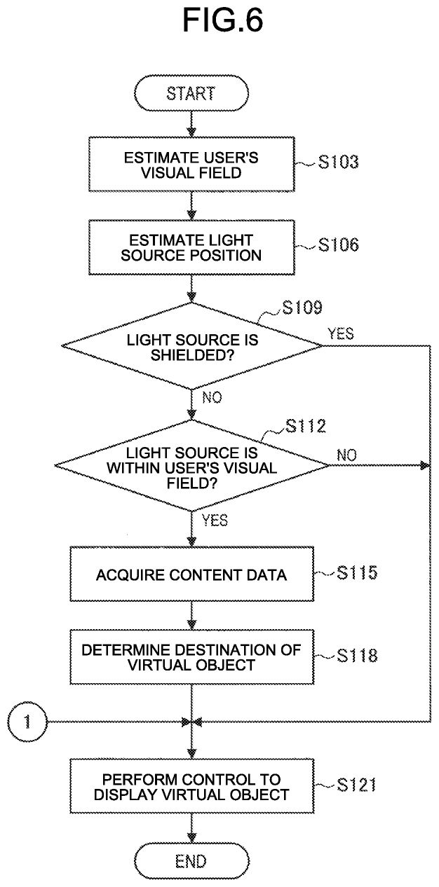

First, output control processing according to the present embodiment will be described with reference to FIG. 6. FIG. 6 is a flowchart illustrating an example of a flow of the output control processing according to the present embodiment.

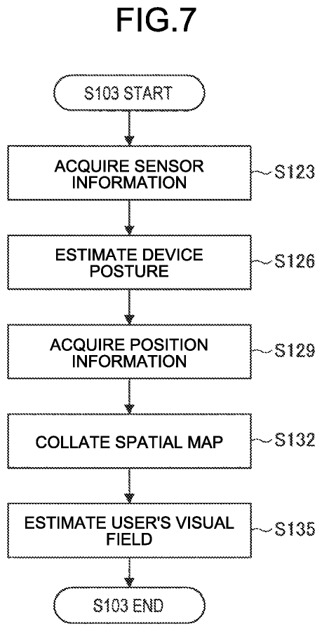

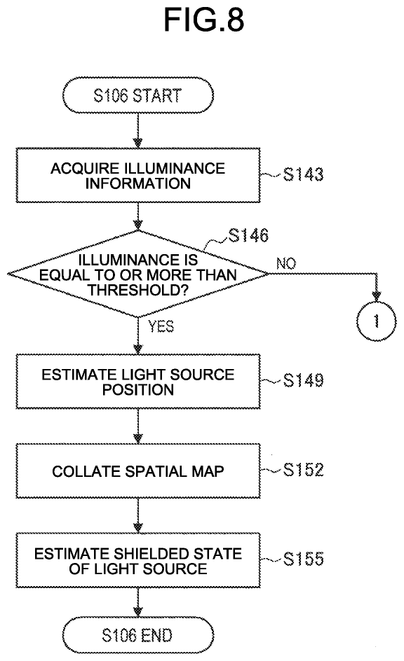

As illustrated in FIG. 6, first, the control unit 100 of the information processing apparatus 10 estimates the user's visual field (Step S103) and estimates the light source position (Step S106). These pieces of such estimation processing may always be performed, or may be performed periodically. The user's visual field estimation processing and the light source position estimation processing may be performed in the order of the steps illustrated in FIG. 6, may be performed in the reverse order, or may be performed in parallel. Details of the user's visual field estimation processing and the light source position estimation processing will be described later with reference to FIGS. 7 and 8.

Next, based on the position of the user, the estimated position of the light source, and the spatial map data, the control unit 100 determines whether or not the light source is shielded by a shield (an artificial object such as a roof and a building or a natural object) when viewed from the position of the user (Step S109).

Then, when the light source is not shielded by the shield (Step S109/No), the content reproduction control unit 105 determines whether or not the light source enters the user's visual field based on the user's visual field and such an estimated light source position (Step S112). The content reproduction control unit 105 determines whether or not the light source enters a current user's visual field, and/or determines whether or not the light source enters the user's visual field when the user visually follows the virtual object, which moves on a movement route preset for the virtual object, based on the current position of the user and the movement route. The content reproduction control unit 105 is also able to analyze a captured image, which is acquired by the outward facing camera 111 and corresponds to the user's visual field, and to determine whether or not the light source is within the user's visual field based on whether or not there is an overexposure spot.

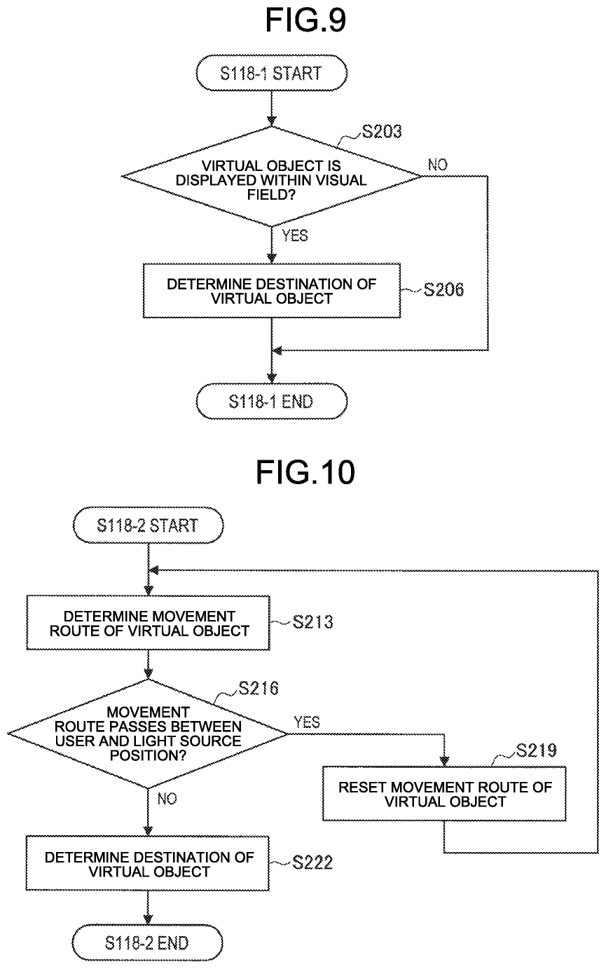

Next, when the light source enters the visual field (Step S112/Yes), the content reproduction control unit 105 acquires the content data from the content data DB 163 (Step S115), and performs processing of determining the destination of the virtual object (Step S118). Specifically, the content reproduction control unit 105 performs processing of changing the display position or the movement route in the real space, which are set for the virtual object, into a range where the light source does not enter the user's visual field (the light back area 35 described with reference to FIG. 5). Details will be described later with reference to FIGS. 9 and 10.

Then, the content reproduction control unit 105 performs controls to display the virtual object at the determined position or route (Step S121). Thus, it becomes possible to perform the display control to avoid the decrease of the visibility of the virtual object due to external light. While moving the virtual object to the destination, while moving the virtual object onto the changed movement route, or when causing the virtual object to appear at the destination, the content reproduction control unit 105 is able to perform audio signal processing of localizing a sound source of a predetermined sound effect or the like to the destination, and to inform the user of the destination by sound even if the destination is out of the user's visual field (that is, outside the display area by the display unit 120) (for example, the back). In addition, when the virtual object is first displayed at a preset position in the real space, this virtual object then enters the user's visual field, and the light source is also within the user's visual field, the content reproduction control unit 105 may determine the destination and move the virtual object thereto. When moving the virtual object, the virtual object may be moved to the destination while being displayed, or the virtual object may be caused to appear at the destination while being not displayed.

Meanwhile, when the light source is shielded (Step S109/Yes), or when the light source is not within the user's visual field (Step S112/No), the content reproduction control unit 105 does not perform the moving processing for the virtual object, and performs control to display the virtual object on a predetermined position or a movement route in the real space based on position information and moving path information which are preset for the virtual object. At this time, in accordance with the illuminance information (quantity of external light), the control unit 100 may perform control to enhance the visibility of the virtual object by blocking light to an extent that the visual field is not too dark by the dimming function of the display unit 120 (transmission-type display).

### 3-2. User's Visual Field Estimation Processing

FIG. 7 is a flowchart illustrating an example of a flow of the user's visual field estimation processing according to the present embodiment. As illustrated in FIG. 7, first, the control unit 100 acquires sensor information from the sensor unit 110 (Step S123), and estimates a device posture by the device posture recognition unit 101 (Step S126). The device posture is the orientation and elevation angle of the HMD that is the information processing apparatus 10 mounted on the user's head, and the device posture recognition unit 101 can calculate the device posture based on sensor information obtained by, for example, the gyro sensor 114, the acceleration sensor 115, and the direction sensor 116.

Next, the control unit 100 acquires the position information of the device (information processing apparatus 10) (Step S129). The position information of the device (for example, latitude/longitude information) can be acquired by the position positioning unit 117. As mentioned above, the position positioning unit 117 may calculate a current position of the device using a SLAM technology, or may calculate the current position of the device by receiving an external radio wave of a GPS or the like.

Next, the control unit 100 performs collation of the spatial map data by the spatial map information processing unit 102 based on an estimation result of the device posture and device position information (Step S132), and estimates the user's visual field (Step S135). Specifically, the control unit 100 can estimate which range on the spatial map data is a range of the user's visual field, what real object is located within the user's visual field, and so on. By obtaining such information on the real object located within the visual field, it becomes possible to grasp the existence of the shield that shields the light source in Step S109 described above.

### 3-3. Sun Position Estimation Processing

FIG. 8 is a flowchart illustrating an example of a flow of the sun position estimation processing according to the present embodiment. As illustrated in FIG. 8, first, the control unit 100 acquires illuminance information from the illuminance sensor 118 (Step S143) and determines whether or not the illuminance is equal to or more than a threshold (Step S146).

When the illuminance is not equal to or more than the threshold (Step S146/No), the content reproduction control unit 105 does not perform the moving processing for the virtual object, and performs the control to display the virtual object on the predetermined position or the movement route in the real space based on the position information and the moving path information which are preset for the virtual object (Step S118 illustrated in FIG. 6).

Meanwhile, when the illuminance is equal to or more than the threshold (Step S146/Yes), the control unit 100 performs light source position estimation by the light source position estimation unit 103 (Step S149). As mentioned above with reference to FIG. 4, the light source position estimation unit 103 estimates the light source position using the position information (device position information) of the user, the date, and the parameters of the sun position data DB 162. In the example illustrated in FIG. 8, when the illuminance (quantity of external light) is equal to or more than the threshold (that is, when brightness equal to or more than a certain level is detected), the estimation processing for the light source position is performed; however, the present embodiment is not limited to this, and the estimation processing for the light source position may be performed without determining the threshold of the illuminance (while skipping Steps S143 to S146).

Next, the control unit 100 performs the spatial map collation by the spatial map information processing unit 102 (Step S152), and estimates a shielded state of the light source (Step S155). Specifically, based on the estimated light source position and the position, shape and the like of the real object, which are included in the spatial map data, the control unit 100 estimates a region where a shadow is generated in the space, that is, a region where the light source is shielded, and the like. By estimating the shielded state of the light source in such a manner, it can be determined in Step S109 described above whether or not a place where the user is located is the region where the light source is shielded.

The spatial map collation processing in the estimation processing for the user's visual field, which is illustrated in Step S132 of FIG. 7, and the spatial map collation processing in the sun position estimating processing illustrated in Step S152 of FIG. 8 are relatively heavy, and accordingly, a processing load of both thereof may be reduced by performing both at the same timing in the spatial map information processing unit 102.

### 3-4. Destination Determination Processing for Virtual Object

Next, destination determination processing for the virtual object, which is illustrated in Step S115 of FIG. 6, will be specifically described with reference to FIGS. 9 and 10. In the present embodiment, for the destination determination processing for the virtual object, specifically assumed are: movement of a preset display position (control to dispose the virtual object in the range where the light source does not enter the user's visual field); and movement of a display position, which is accompanied by a change of the movement route (movement control of the virtual object, which passes the range where the light source does not enter the user's visual field).

### Determination of Destination of Virtual Object

FIG. 9 is a flowchart illustrating an example of destination determination processing for the virtual object according to the present embodiment. As illustrated in FIG. 9, first, the content reproduction control unit 105 acquires display position information of each virtual object from the content data DB 163, and determines whether or not the virtual object is displayed within the user's visual field (Step S203). The display position information of the virtual object is, for example, information on a predetermined appearance position in the real space, which is set in advance by a content provider side (in the case of a virtual object floating or moving a little, the appearance position may be an “appearance range”). The content reproduction control unit 105 refers to the current position of the user, the user's visual field, the spatial map, and the content data, and determines whether or not the virtual object is displayed within the user's visual field. At this time, the content reproduction control unit 105 may already display the virtual object in the user's visual field based on the display position information.

Next, the content reproduction control unit 105 determines the destination of the virtual object in the range where the light source does not enter the user's visual field (Step S206). The range where the light source does not enter the user's visual field is, for example, the light back area 35 described with reference to FIG. 5.

The moving processing for the virtual object has been described above. Here, the case where the information on the display position is preset in the virtual object has been described; however, the present embodiment is not limited to this, and the display position of the virtual object may be set at random according to a predetermined rule. In this case, when the display position set at random is within the range where the light source enters the user's visual field, the content reproduction control unit 105 performs the processing for moving the display position (for example, may set the display position at random again and determine the same, or may determine the destination in the light back area 35).

Further, the content reproduction control unit 105 may cause the virtual object to appear at a default display position and then move the virtual object to the destination, or may cause the virtual object to appear on the destination (disposition destination) without causing the virtual object to appear at the default display position.

### Change of Movement Route of Virtual Object

FIG. 10 is a flowchart illustrating an example of destination determination processing accompanied by a movement route change of the virtual object according to the present embodiment. Depending on contents, it is possible to set a predetermined movement route in the real space for each virtual object. Alternatively, it is also possible to make setting in advance to determine the movement route for each virtual object according to a predetermined rule (moving to escape from the user, rotating around the user, rotating in the sky, moving along the ground, and so on). In this case, when the user visually follows the virtual object moving on the movement route, the light source enters the visual field, and then it is assumed that it is difficult to see the virtual object, and that the moving virtual object is lost, and such an outdoor experience of the AR content cannot be fully enjoyed. Therefore, in the present embodiment, based on the preset/randomly determined movement route, the current position of the user, and the estimated light source position, performed is processing for setting the movement route that passes through the range where the light source does not enter the user's visual field, and determining the destination of the virtual object.

Specifically, as illustrated in FIG. 10, first, the content reproduction control unit 105 determines (acquires) the movement route of the virtual object in the real space based on the content data (Step S213). When the movement route is set at random according to a predetermined rule, the content reproduction control unit 105 sets the movement route at random and determines (acquires) the movement route in the real space.

Next, the content reproduction control unit 105 determines whether or not the movement route passes between the user and the light source position (Step S216). That is, based on the current position of the user and the estimated light source position, the content reproduction control unit 105 determines whether or not the movement route passes the range where the light source enters the user's visual field. Since it is assumed that the user visually follows the virtual object moving on the movement route, the content reproduction control unit 105 predicts not only the current user's visual field but also a change of the user's visual field when the user visually follows the virtual object moving on the moving path, and determines whether or not the movement route passes through the range where the light source enters the user's visual field.

Next, when the movement route passes between the user and the light source position (Step S216/Yes), the content reproduction control unit 105 resets the movement route (Step S219). For example, the content reproduction control unit 105 may set the movement route at random again according to a predetermined rule, or may set the movement route passing through the light back area 35 described with reference to FIG. 5.

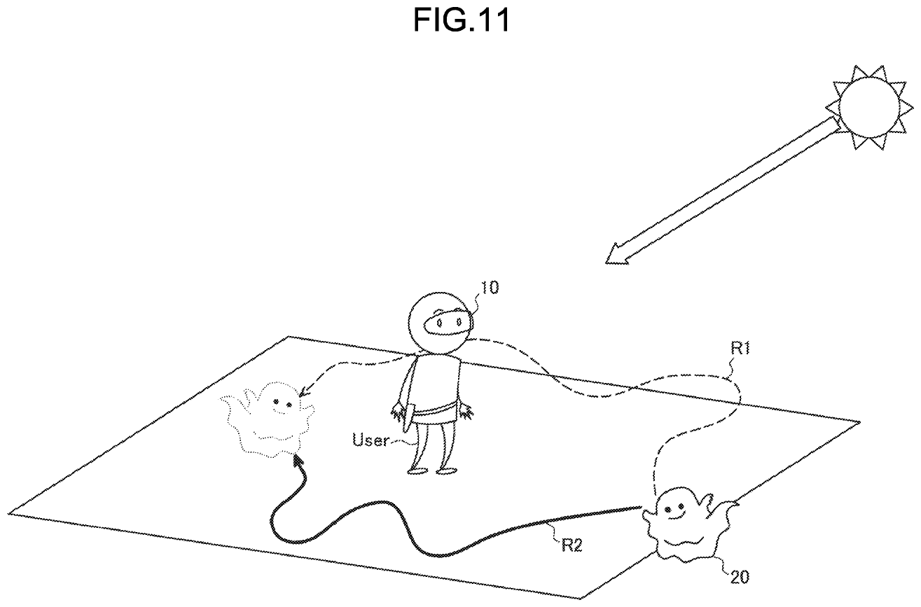

Then, when the movement route does not pass between the user and the light source position (Step S216/No), the content reproduction control unit 105 determines the movement route and the destination of the virtual object (Step S222). For example, as illustrated in FIG. 11, when an initial movement route R1 of a virtual object 20 passes between the user and the light source (sun), the movement route is reset, and is determined as a movement route R2 that does not pass between the user and the light source position.

### 4. Use Cases

Next, use cases of the present embodiment will be described with specific examples.

<Use Case 1: Moving a Virtual Character that Appears from a Specific Place in the Real World to a Position where the Virtual Character is Easy to See>

The information processing apparatus 10 executes operations to be described below using the following data.
Content data: Game content data to be executed on a game engine
Spatial map data: Data of a spatial map of streets and areas of the real world, which serve as a stage of a game and of character appearance positions (for example, a manhole position and the like)

### Operation Example

When the user walks in a game area while wearing the information processing apparatus 10 (optical transmission-type HMD) and approaches a manhole (an example of the virtual object appearance position), AR display control is performed in which the virtual character (for example, a ghost: an example of the virtual object) pops out of the manhole together with a sound effect.

Then, when the character and the sun are within the user's visual field as a result of the light source position estimation, the information processing apparatus 10 moves the character to the light back area.

By directing the line of sight toward the character, the user naturally turns in the opposite direction to the sun, and can visually recognize the character firmly.

### Implementation Variation

The information processing apparatus 10 may prescribe the appearance position of the character not by spatial map data of a specific area but by marker recognition or general object recognition, each using image recognition (in which, for example, the character comes out from a specific marker, the character comes out when an image of the manhole is recognized, and so on).

Further, the information processing apparatus 10 may express a sound when the character pops out of the manhole or moves by a 3D audio having an audio effect corresponding to the position (for example, using a virtual phones technology (VPT) technology).

<Use Case 2: Setting Up a Movement Route of the Virtual Character Moving in an Area so that the User can Easily find the Movement Route>

The information processing apparatus 10 executes operations to be described below using the following data.
Content data: Game content data to be executed on a game engine
Spatial map data: Data in which a movable range of the character is set on a spatial map of streets and areas of the real world, which serve as a stage of a game

### Operation Example

When the user walks in a game area while wearing the information processing apparatus 10 (optical transmission-type HMD), AR display control is performed in which a virtual character (for example, a present hanging in a balloon) appears with a sound effect, and starts to move along an initially set movement route.

Then, when the movement route is a route where the character moves between the position of the user and the position of the sun as a result of the light source position estimation, the information processing apparatus 10 resets the movement route of the character so that the movement route avoids the sun side.

By directing the line of sight toward the character, the user naturally turns in the opposite direction to the sun, and can visually recognize the character firmly.

### Implementation Variation

The movement route of the character may be selected from a plurality of predetermined patterns, or may be autonomously set by artificial intelligence (AI).

Further, the information processing apparatus 10 may express a sound when the character appears and a sound when the character moves by the 3D audio having an audio effect corresponding to the position.

<Use Case 3: Moving a Virtual Character that Appears from a Specific Place in the Real World to a Position where the Hand can be Easily Recognized>

The information processing apparatus 10 executes operations to be described below using the following data and an image recognition function.
Content data: Game content data to be executed on a game engine, in which an interaction can be performed with the virtual character when the hand is recognized (for example, the interaction is such that presented are an AR display in which a beam looks like coming out of the hand and a sound effect, and further, that presented are an AR display and a sound effect, in which the character is defeated by the beam).
Spatial map data: Data of a spatial map of streets and areas of the real world, which serve as a stage of a game and of character appearance positions (for example, a manhole position)
Hand recognition function: A function (image recognition unit 104) to recognizing the extended hand of the user from an image of the outward facing camera 111 mounted on the device (information processing apparatus 10)

### Operation Example

When the user walks in the game area while wearing the information processing apparatus 10 (optical transmission-type HMD) and approaches a manhole, AR display control is performed in which the virtual character (for example, a ghost) pops out of the manhole together with a sound effect.

Then, when the character and the sun are within the user's visual field as a result of the light source position estimation, the information processing apparatus 10 moves the character to the light back area.

By directing the line of sight toward the character, the user naturally turns in the opposite direction to the sun, and can visually recognize the character firmly, and in addition, the hand extended toward the character is firmly recognized by the image recognition unit 104 without being backlit, and the interaction of defeating the character by the beam can be performed.

### Implementation Variation

The interaction with the character is not limited to beam emission from the hand, and may be manually rubbing the character, manually pushing the character, and so on.

Further, the information processing apparatus 10 may prescribe the appearance position of the character by marker recognition by image recognition or general object recognition thereby instead of the spatial map data of the specific area.

Moreover, the information processing apparatus 10 may express a sound when the character pops out of a manhole and a sound when the character moves by the 3D audio having an audio effect corresponding to the position.

<Use Case 4: Setting the Route of the Virtual Character Moving in the Area so that the Hand can be Easily Recognized>

The information processing apparatus 10 executes operations to be described below using the following data and an image recognition function.
Content data: Game content data to be executed on a game engine, in which an interaction can be performed with the virtual character when the hand is recognized (for example, a beam is emitted from the hand to defeat the character, and so on)
Spatial map data: Data in which a movable range of the character is set on a spatial map of streets and areas of the real world, which serve as a stage of a game
Hand recognition function: A function (image recognition unit 104) to recognizing the extended hand of the user from an image of the outward facing camera 111 mounted on the device (information processing apparatus 10)

### Operation Example

When the user walks in a game area while wearing the information processing apparatus 10 (optical transmission-type HMD), AR display control is performed in which a virtual character (for example, a present hanging in a balloon) appears with a sound effect, and starts to move along an initially set movement route.

Then, when the movement route is a route where the character moves between the position of the user and the position of the sun as a result of the light source position estimation, the information processing apparatus 10 resets the movement route of the character so that the movement route avoids the sun side.

By directing the line of sight toward the character, the user naturally turns in the opposite direction to the sun, and can visually recognize the character firmly, and in addition, the hand extended toward the character is firmly recognized by the image recognition unit 104 without being backlit, and the interaction of defeating the character by the beam can be performed.

### Implementation Variation

The interaction with the character is not limited to beam emission from the hand, and may be manually rubbing the character, manually pushing the character, and so on.

The movement route of the character may be selected from a plurality of predetermined patterns, or may be autonomously set by AI.

Further, the information processing apparatus 10 may express a sound when the character appears and a sound when the character moves by the 3D audio having an audio effect corresponding to the position.

### 5. Summary

As mentioned above, in the information processing system according to the embodiment of the present disclosure, it becomes possible to perform the display control to avoid the decrease of the visibility of the virtual object due to external light.

In the information processing system according to the present embodiment, such effects are exerted that easiness to play AR and MR game contents for outdoor use is improved, that an ability to guide the user in outdoor navigation applications using AR and MR is improved, that attention from the user to AR and MR shows at outdoor theme parks or the like is increased, and that an advertising effect in outdoor advertising and commercial message (CM) display using AR and MR is improved.

Further, in the information processing system according to the present embodiment, adaptation of the AR and MR games to outdoor use by plugging in the same in a 3D game development tool can be simplified.

The preferred embodiments of the present disclosure have been described above in detail with reference to the accompanying drawings; however, the present technology is not limited to such examples. It is obvious that those having ordinary knowledge in the technical field of the present disclosure can conceive various modifications or alterations within the scope of the technical idea described in the patent claims, and it is understood that these also naturally fall within the technical scope of the present disclosure.

For example, it is possible to create a computer program for causing hardware such as the CPU, the ROM, and the RAM, which is built in the above-mentioned information processing apparatus 10 to exert the functions of the information processing apparatus 10. Further, a computer-readable storage medium that stores the computer program therein is also provided.

Further, the effects described in this description are merely illustrative or exemplary, and are not restrictive. That is, the technology according to the present disclosure can exhibit other effects, which are obvious to those skilled in the art from the description in the present description, in addition to or instead of the above effects.

Note that the present technology may also adopt such configurations as follows.

(1)

An information processing apparatus comprising:

a control unit that performs display control to dispose a virtual object preferentially on a second region rather than on a first region, the first region being a region in a real space from which first visibility is obtained, and the second region being a region in the real space from which second visibility higher than the first visibility is obtained.

(2)

The information processing apparatus according to (1), wherein the control unit determines the second region having higher visibility than the first region based on an illuminance environment.

(3)

The information processing apparatus according to (2),

wherein the illuminance environment is illuminance information obtained by sensing,

the first region is a region having an illuminance that exceeds a first threshold, and

the second region is a region having an illuminance that is less than the first threshold.

(4)

The information processing apparatus according to (2),

wherein the illuminance environment is position information of a light source,

the first region is a region including a direction in which the light source is located with respect to a position of a user, and

the second region is a region including a direction opposite to the direction in which the light source is located with respect to the position of the user.

(5)

The information processing apparatus according to (4),

wherein the illuminance environment further includes position information of a shield, and

the control unit defines, as the second region, a region shaded by the shield.

(6)

The information processing apparatus according to (4) or (5),

wherein the light source is the sun, and

the control unit estimates a position of the sun as the position information of the light source based on a current position of the user, and a date and time.

(7)

The information processing apparatus according to any one of (1) to (6),

wherein the control unit

acquires display position information corresponding to a three-dimensional position of the real space, the display position information being preset for the virtual object, and

performs control to change a position indicated by the display position information into a range of the second region when the position is within a range of the first region.

(8)

The information processing apparatus according to any one of (1) to (7),

wherein the control unit

acquires display position information corresponding to a three-dimensional position of the real space, the display position information being preset for the virtual object, determines a movement route of the virtual object based on the display position information, and

performs control to change the movement route of the virtual object into a range of the second region when the movement route passes through a range of the first region.

(9)

The information processing apparatus according to any one of (1) to (8), wherein a region including the direction opposite to the direction in which the light source is located with respect to the position of the user is an area opposite to the light source, the area being surrounded by a spherical surface of which center is a viewpoint of the user and of which maximum display distance of the virtual object is a radius, and by a plane orthogonal to a straight line that connects the viewpoint of the user and a position of the light source to each other.

(10)

The information processing apparatus according to any one of (1) to (9),

wherein the control unit

performs audio signal processing of localizing a predetermined sound source to a disposition destination of the virtual object, and

performs control to output, from an audio output unit, an audio signal subjected to the audio signal processing.

(11)

The information processing apparatus according to (8),

wherein the control unit

performs audio signal processing of localizing a predetermined sound source to the movement route of the virtual object, and

performs control to output, from an audio output unit, an audio signal subjected to the audio signal processing.

(12)

The information processing apparatus according to any one of (4) to (6),

wherein the control unit

refers to positions of a plurality of users, and determines the first and second regions common to the plurality of users.

(13)

The information processing apparatus according to any one of (1) to (12),

wherein the control unit

performs display control to dispose the virtual object in the real space via a transmission-type display unit.

(14)

An information processing method comprising:

performing, by a processor, display control to dispose a virtual object preferentially on a second region rather than on a first region, the first region being a region in a real space from which first visibility is obtained, and the second region being a region in the real space from which second visibility higher than the first visibility is obtained.

(15)

A program for causing a computer to:

function as a control unit that performs display control to dispose a virtual object preferentially on a second region rather than on a first region, the first region being a region in a real space from which first visibility is obtained, and the second region being a region in the real space from which second visibility higher than the first visibility is obtained.

### REFERENCE SIGNS LIST

10 Information Processing Apparatus
100 Control Unit
101 Device Posture Recognition Unit
102 Spatial Map Information Processing Unit
103 Light Source Position Estimation Unit
104 Image Recognition Unit
105 Content Reproduction Control Unit
110 Sensor Unit
111 Outward Facing Camera
112 Inward Facing Camera
113 Microphone
114 Gyro Sensor
115 Acceleration Sensor
116 Direction Sensor
117 Position Positioning Unit
120 Display Unit
130 Speaker
140 Communication Unit
150 Operation Input Unit
160 Storage Unit
161 Spatial Map Data DB
162 Sun Position Data DB
163 Content Data DB

1. An information processing apparatus comprising:
a control unit that performs display control to dispose a virtual object preferentially on a second region rather than on a first region, the first region being a region in a real space from which first visibility is obtained, and the second region being a region in the real space from which second visibility higher than the first visibility is obtained.

2. The information processing apparatus according to claim 1, wherein the control unit determines the second region having higher visibility than the first region based on an illuminance environment.

3. The information processing apparatus according to claim 2,
wherein the illuminance environment is illuminance information obtained by sensing,
the first region is a region having an illuminance that exceeds a first threshold, and
the second region is a region having an illuminance that is less than the first threshold.

4. The information processing apparatus according to claim 2,
wherein the illuminance environment is position information of a light source,
the first region is a region including a direction in which the light source is located with respect to a position of a user, and
the second region is a region including a direction opposite to the direction in which the light source is located with respect to the position of the user.

5. The information processing apparatus according to claim 4,
wherein the illuminance environment further includes position information of a shield, and
the control unit defines, as the second region, a region shaded by the shield.

6. The information processing apparatus according to claim 4,
wherein the light source is the sun, and
the control unit estimates a position of the sun as the position information of the light source based on a current position of the user, and a date and time.

7. The information processing apparatus according to claim 1,
wherein the control unit
acquires display position information corresponding to a three-dimensional position of the real space, the display position information being preset for the virtual object, and
performs control to change a position indicated by the display position information into a range of the second region when the position is within a range of the first region.

8. The information processing apparatus according to claim 1,
wherein the control unit
acquires display position information corresponding to a three-dimensional position of the real space, the display position information being preset for the virtual object,
determines a movement route of the virtual object based on the display position information, and
performs control to change the movement route of the virtual object into a range of the second region when the movement route passes through a range of the first region.

9. The information processing apparatus according to claim 4, wherein a region including the direction opposite to the direction in which the light source is located with respect to the position of the user is an area opposite to the light source, the area being surrounded by a spherical surface of which center is a viewpoint of the user and of which maximum display distance of the virtual object is a radius, and by a plane orthogonal to a straight line that connects the viewpoint of the user and a position of the light source to each other.

10. The information processing apparatus according to claim 1,
wherein the control unit
performs audio signal processing of localizing a predetermined sound source to a disposition destination of the virtual object, and
performs control to output, from an audio output unit, an audio signal subjected to the audio signal processing.

11. The information processing apparatus according to claim 8,
wherein the control unit
performs audio signal processing of localizing a predetermined sound source to the movement route of the virtual object, and
performs control to output, from an audio output unit, an audio signal subjected to the audio signal processing.

12. The information processing apparatus according to claim 4,
wherein the control unit
refers to positions of a plurality of users, and determines the first and second regions common to the plurality of users.

13. The information processing apparatus according to claim 1,
wherein the control unit
performs display control to dispose the virtual object in the real space via a transmission-type display unit.

14. An information processing method comprising:
performing, by a processor, display control to dispose a virtual object preferentially on a second region rather than on a first region, the first region being a region in a real space from which first visibility is obtained, and the second region being a region in the real space from which second visibility higher than the first visibility is obtained.

15. A program for causing a computer to:
function as a control unit that performs display control to dispose a virtual object preferentially on a second region rather than on a first region, the first region being a region in a real space from which first visibility is obtained, and the second region being a region in the real space from which second visibility higher than the first visibility is obtained.
